(19) United States
(12) Patent Application Publication
(10) Pub. No.: US 2018/0225723 A1
(43) Pub. Date: Aug. 9, 2018

(54) ALLOCATION OF DESIGNS TO PRODUCTS

(71) Applicant: HP INDIGO B.V., Amstelveen (NL)

(72) Inventor: Gideon Amir, Ness Ziona (IL)

(73) Assignee: HP INDIGO B.V., Amstelveen (NL)

(21) Appl. No.: 15/748,315

(22) PCT Filed: Oct. 29, 2015
(86) PCT No.: PCT/EP2015/075177

§ 371 Date: Jan. 29, 2018

(51) Int. Cl. G06Q 30/02

(52) U.S. Cl. CPC G06Q 30/0276; G06Q 30/0205; G06Q 30/0259

(57) ABSTRACT

In an example, processing apparatus comprises a product module to identify products of a plurality of product types. Each of the products has sales packaging comprising a display region which is to receive a design. A location module may identify at least one retail location for a plurality of the products. A design module may receive a design to be displayed on at least one display region. An allocation module may determine, for at least one design, a retail location at which the design is to be displayed and a product type on which the design is to be displayed. A print instruction module may determine print instructions to print the design for display in a display region. A distribution instruction module may determine a distribution instruction for sending at least one of a printed design and the print instructions to at least one retail location.

### BACKGROUND

In dissemination of information, for example for the promotion of products and services, it may be intended to provide information to a selected target audience. Well targeted information, such as advertising, is likely to effectively convey a message. In some examples, printed information is intended for long term use, being embodied in an article which has value to a target recipient of the information, such as a pen, or a mouse mat, or the like. Such an article is less likely to be immediately discarded, compared for example a newspaper or flyer and therefore a recipient may be repeatedly exposed to its content and the information may be seen by multiple recipients over time.

### BRIEF DESCRIPTION OF DRAWINGS

Examples will now be described, by way of non-limiting example, with reference to the accompanying drawings, in which:

FIG. 1 is a simplified schematic of an example processing apparatus for allocation of designs for sales packaging;

FIG. 2 is an example of an interface;

FIG. 3 is a simplified schematic of another example processing apparatus for allocation of designs for sales packaging;

FIG. 4 is a flowchart of an example method for allocation of designs for sales packaging;

FIG. 5 is a flowchart of an example method for refining selections;

FIG. 6 is a flowchart of another example method for allocation and distribution of designs for sales packaging;

FIG. 7 is a flowchart of another example method for allocation of designs for sales packaging;

FIGS. 8a-8c show examples of product packaging; and

FIG. 9 is an example of a processor in association with a computer readable medium.

### DETAILED DESCRIPTION

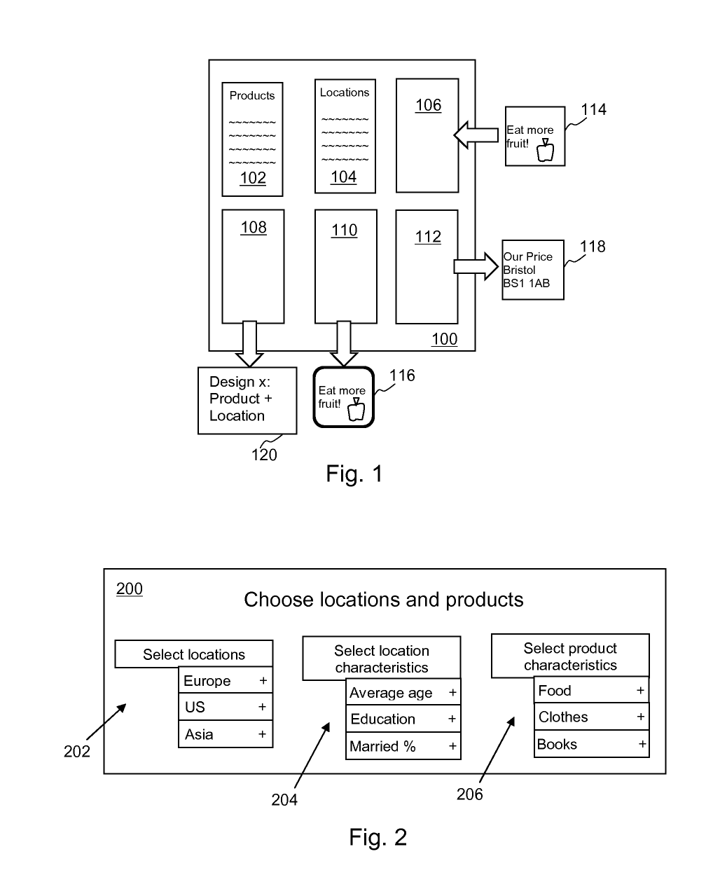

FIG. 1 is a schematic representation of a processing apparatus 100 comprising a product module 102, a location module 104, a design module 106, an allocation module 108, a print instruction module 110 and a distribution instruction module 112.

The product module 102 is to identify products of a plurality of product types, each of the products having sales packaging, wherein the sales packaging of each of the products comprises an advertising region thereof which is to receive a design. In some examples, the design may be printed as a label for application to a package. In other examples, the design may be printed directly on the package (for example, the design may be printed in one step with the package graphics, or the design may be printed onto a package on which package graphics have already been printed). In one example, the product module 102 may comprise a list, or database of product types, which may for example be associated with product characteristics, as further discussed below.

The location module 104 identifies a retail location for a plurality of products identified in the product module 102. This may be a current location, an intended location or a usual location. For example, it may be that a retail location (which may be retail outlet or a shop, or may be a region of a plurality of retail outlets or shops such as a geographical region) usually stocks a particular product type. This could be identified as a retail location for that product type regardless of current stock levels. In some examples, the retail location may be the actual location of a particular instance of a product of a product type.

The design module 106 receives a design 114 to be displayed on at least one display region of the sales packaging of at least one product, for example to be added to the display region of sales packaging as a printed label to be attached to a display region, or to be printed directly on display region of the sales packaging. This design 114 may for example be uploaded from a computer readable medium, or provided via an interface, for example over the Internet or designed within the design module. The design 114 may be an advertising or promotional design.

The allocation module 108 is to determine, for at least one design (which in some examples may be a design 114 which has been received by the design module 106), a retail location at which a design is to be displayed and a product type on which the design is to be displayed. As is described in greater detail below, the allocation of a design to a product and retail location may be determined automatically, partially automatically or based on user input. This may for example comprise an association 120 between a design, a product and a location.

The print instruction module 110 determines print instructions to print the design 114 as a printed design 116 for display in the display region of the sales packaging of the product type. Such a design may be intended to match a particular size of shape of the display region of sales packaging, which may vary between product types. Therefore, determining print instructions may comprise determining a size and/or shape of a design to be printed, and scaling the design accordingly. In some examples, aspects of the design, for example the coloring thereof, may be adapted based on a product or location. In some examples, a feature such as a border may be determined to match the packaging of a particular product, for example such that the design appears to be part of the initial sales packaging design graphics. As the print instructions may in some examples be determined after the product type and/or retail location has been identified, aspects thereof may be tailored to the product/location in a straight forward manner. In some examples, the design may be printed on a label, and such labels may comprise an attachment means, for example an adhesive backing. The print instructions may be executed so as to print the design on the product sales packaging before the product is dispatched for sale or after the product is packaged (for example, the print instructions may be executed at a retail location). If the design is printed on at least one labels, it may be that the distribution of the labels and distribution of the product are separate processes.

The distribution instruction module 112 determines a distribution instruction for sending at least one design to at least one retail location determined by the allocation module 108. In some examples, printed designs are sent, for example as labels or products in sales packaging bearing the design. In some examples, the print instructions for printing the design may be sent, for example electronically. In some examples, the distribution instruction module 112 may determine print instructions to print an address label 118 or the like, or may send print instructions for printing the design, for example electronically or on a computer readable medium. In some examples, the distribution instruction module 112 may comprise an output, instructing a user of the processing apparatus 100 regarding distribution of printed labels or packages, or the distribution of print instructions.

Applying the designs to sales packaging (i.e. the packaging presented to the consumer at the point of purchase) may mean that the consumer has repeated exposure to the design. It may be the case that a product is used over time from its sales packaging (for example, beverages or cereals may be poured from their packaging). In addition, the design may add to the appeal of the product, for example if the design is attractive, or interesting or for example comprises a coupon or offer entitling a consumer to a discount. Further, the design may be applied relatively late in the product production line, for example being applied to a printed sales package, and/or in some examples at the retail outlet location following distribution. It may be the case that different products bear different designs. In that case, the consumer may themselves select the design they will be repeatedly exposed to, thus providing a communication which is to some extent invited by a user, possibly indicating a predisposition towards a message communicated by the design. Furthermore, in examples where the design is printed on a label, the production of labels may be carried out relatively quickly, unlike the distribution of some products (for example, food products, refrigerated products or fragile products) which is relatively complex, often requiring specialised transportation, storage and tracking. Therefore, separating the distribution of labels from the distribution of the product may allow for more responsive content adaptability of packages. This may for example allow content to be distributed which corresponds to current events, or closely tracks market conditions or the like. In contrast, changing pre-printed sales packaging may be a relatively long process, taking time to reach the market place.

In some examples, for fast-moving consumer goods such as dairy products, designs may be printed directly on sales packages may be carried out. For products with a longer shelf life, labels may be printed. In other examples, the products may be limited to fast moving and/or long shelf life products. A user may select which of direct sales package printing and label printing is intended.

FIG. 2 shows an example of an interactive user interface 200, which in this example is a graphical user interface for display on a screen or the like. In some examples, the allocation module 108 may provide such a user interface 200 to receive user input, for example indicating user preferences. A user of the interface 200 may be an advertising entity or promoter, and the interface 200 may allow the user to target a promotional message. In this example, the user interface 200 allows a user to input an indication 202 of a geographical zone for a retail location, an indication 204 of characteristics of a retail location, and an indication 206 of at least one characteristic of a product type. The allocation may be an iterative process, and in some examples a choice in one category may reduce the choices in other categories such that compatible options are displayed. This simplifies a targeting process for the user, and may reduce user frustration. In the example of the figures, a “+” sign indicates that there are options for selection within a category. Selecting Europe may for example result in the presentation of a list of countries in Europe, and selecting one of those countries may result in the presentation of a list of regions in that country, and so on.

In some examples, the user interface 200 may allow a user to specify other factors, such as: price of labels, volume of packages or labels to be printed, timing (for example, start date and/or duration) of design exposure. In some examples, the products or locations may be approved by, for example, the brand owner of the product or a manager of a retail location. This approval may depend on the content of a submitted design. For example the approval may be subject to verification that a design is non-offensive, is in line with the brand, and/or does not promote a competitor or competing product or the like. In such examples, if pre-approval of the design has been obtained, those products or locations at which use of the design has been approved may be displayed to the user.

The indication 202 of at least one geographical location may comprise indicating a geographical designation (for example, country, state, county, city, town, etc.), a postal district (for example using postal codes or zip codes) or some other indication. While FIG. 2 shows a list, the options could for example be presented graphically.

The indication 204 of at least one characteristic of geographical locations may comprise any or any combination of an indication of population, population density, house values distribution, residents' ages distribution (males and females), races, household income distribution, rental costs distribution, average household size, average family size, percentage of married-couple families, percentage of married-couple families with children, percentage of single-mother households, percentage of never married males and females, educational attainment distribution, bedrooms in owner-occupied houses and condos, percentage of units with mortgage, average number of vehicles in household, average housing prices per type, houses age distribution, modes of transportation to work distribution, time leaving home to go to work distribution, travel time to work distribution, occupations distribution for males and females, children education distribution by ages, house heating means distribution, or the like.

The indication 206 of at least one characteristic of a product type may allow selection of a characteristic of a product or service being promoted in the promotional material. In some examples, the user may indicate a characteristic of their own product/service and this may be matched with a complementary product to which a design is to be applied. It may be the case that a particular brand owner may not be content to advertising competing products. Therefore, in some examples, ‘complementary’ may comprise similar, but non identical products, or products which may appeal to the same demographic even if they are dissimilar. For example, a user may be able to indicate a heading, such as “Home and home products”. The user may indicate the nature of their own business. For example, if a user is promoting painting contractors, this could be indicated and the allocation module 108 may (for example based on the content of a look up table or the like) suggest allocation of the design to at least one paint product. If the user indicates the promotion relates to child care or child entertainment (for example the promotion of nurseries, safari parks or the like), then the allocation module 108 may suggest allocation of the design to at least one product for children or parents (for example, nursery products). The user may therefore chose from reduced list, which includes products which are, or are likely to be, complementary to the subject of the promotion.

In some examples, as will be described in greater detail with reference to FIGS. 6 and 8b below, there may be promotion of the service provided by the processing apparatus 100. In such an example, a code, which may for example be an alphanumeric code or embodied in a machine readable tag, may be distributed as a label or directly printed in the display region of a sales packaging, for example with a message inviting users to promote their product in that space. In such an example, the allocation module 108 may receive an indication that the tag has been read, for example scanned using an internet connected device such as a mobile phone. The tag may have an association with the product and/or the retail location through which the product was distributed. In such an example, the allocation module 108 may automatically allocate a design to that product and/or retail location, or may prepopulate options within an interface, for example the interface 200, based on the product and/or retail location.

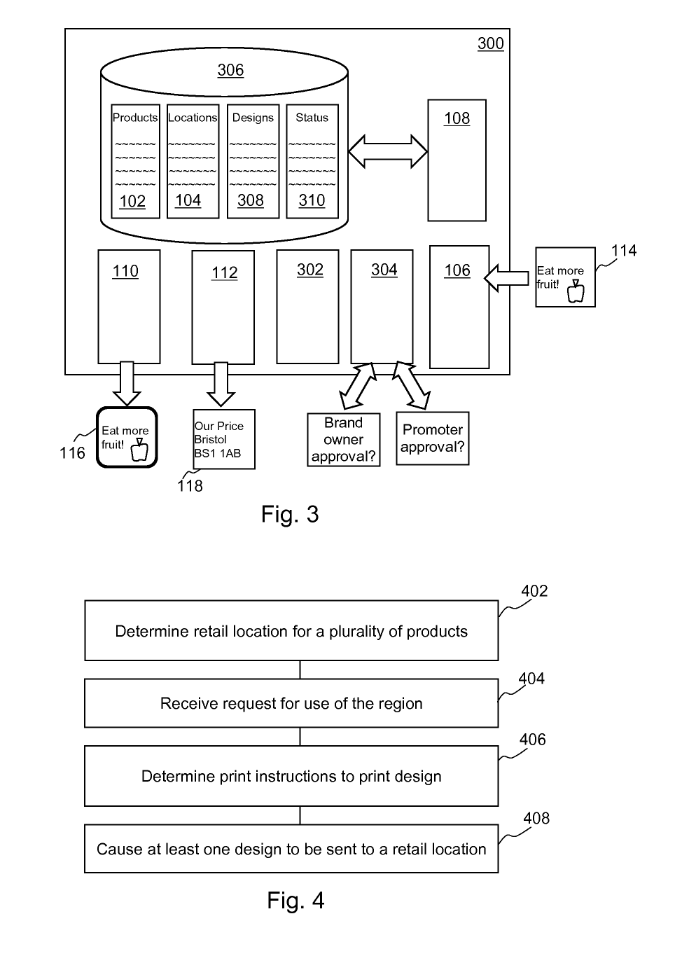

FIG. 3 is another example of a processing apparatus 300. Components in common with the apparatus 100 of FIG. 1 are labelled with like numbers. In this example, the processing apparatus 300 further comprises a tracking module 302 to track at least one handling of a design at the retail location, and an approval module 304 to receive at least one approval of a design.

In this example, the product module 102 and location module 104 are components of a database 306, which further comprises a design identifier module 308, and a status indication module 310. The design identifier module 308 may comprise identifiers providing a reference to a design, and may be associated with a product, location and/or status indication. A status indication held in the status indication module 310 may for example comprise ‘design(s) approved’, ‘design(s) printed’ ‘designs(s) dispatched’ design(s)/label(s) bearing design received at retail location′, ‘design(s)/label(s) bearing design applied to products’, or the like. Such a status may be updated based on information received by the tracking module 302. In some examples, the tracking module 302 may receive or maintain a record of statuses for at least one design, for example based on information received thereby (which may be an indication that a machine readable tag has been read). In some examples, the status indication may comprise at least one of a start or a release date for the design, and an end date. In some such examples, a design may be exposed for a fixed duration, or held back until a predetermined date (for example, to coincide with product, service or promotion availability or the like).

The allocation module 108 in this example determines associations within the database 306. Therefore, the allocation module 108 may store, in relation to a design which may be identified with a design identifier, at least one product, at least one location, and at least one status. These associations may be used to determine distribution information, the content of print instructions, tracking and reporting information and the like.

In this example, the approval module 304 obtains an approval from both a brand owner, associated with a product to which a design is to be applied, and a promoter, who wishes to promote services or products through use of a design. The promoter may for example provide approval based on appearance, for example indicating that colors, text and/or layout of the design is as intended. The brand owner may consider if the content of the design complements, or is suitable for, their product. For example the brand owner may verify that a design is non-offensive, is in line with the brand, and/or does not promote a competitor or competing product or the like. In some examples, the brand owner may receive a fee for featuring a design on the product. Obtaining approval may for example comprise sending the design, either in printed form or electronically to at least one of a promoter and the brand owner. In some examples, the print instruction module 110 may determine initial print instructions to print a ‘proofing’ design which is sent for approval by the promoter. In some examples, the design may be sent electronically to the brand owner. On receipt of any requested approval(s), the print instruction module 110 may determine further print instructions to print a plurality of labels for applying to products or to print the design onto a plurality of packages.

FIG. 4 is a flowchart of a method comprising, in block 402, determining a retail location for a plurality of products of each of a plurality of product types. Each of the products has a sales packaging, and the sales packaging of each of the products comprises a display region thereof which is to receive a design. In block 404, the method further comprises receiving a request for use of the display region. In this example, the request indicates a design, a retail location and product type. In some examples, the request may be submitted via an interface, such as the interface described in relation to FIG. 2. In some examples, at least part of a request may be received in the form of a scanned machine readable tag, as is further discussed below in relation to FIG. 6. In block 406, print instructions are determined, the print instructions being an instruction to print the design for display in a display region of the sales packaging of the product type indicated in the request. In some examples, the print instructions may comprise an instruction to print a plurality of self-adhesive labels. In some examples the print instructions may comprise an instruction to print plurality of sales packages with the design. Block 408 comprises causing at least one design (for example, a printed design, comprising printed label or a product packaged in sales packaging bearing the design, or print instructions for printing a label or printing the design on product sale packaging) to be sent to a retail location indicated in the request. In some examples, the design (for example as a printed label or as print instructions) may be for application at the retail location to a display region of the sales packaging of at least one product of the product type indicated in the request.

For example, the indication of retail location in block 404 may comprise an indication of a geographical zone (for example a country, state, city, town, postal region or the like), and block 408 may comprise causing a label, sales packaging and/or print instructions to be sent to at least one location within the zone. In some examples, the indication of retail location in block 404 is an indication of the characteristics of a retail location, and block 406 may comprise causing a label, sales packaging and/or print instructions to be sent to at least one retail location having the characteristics.

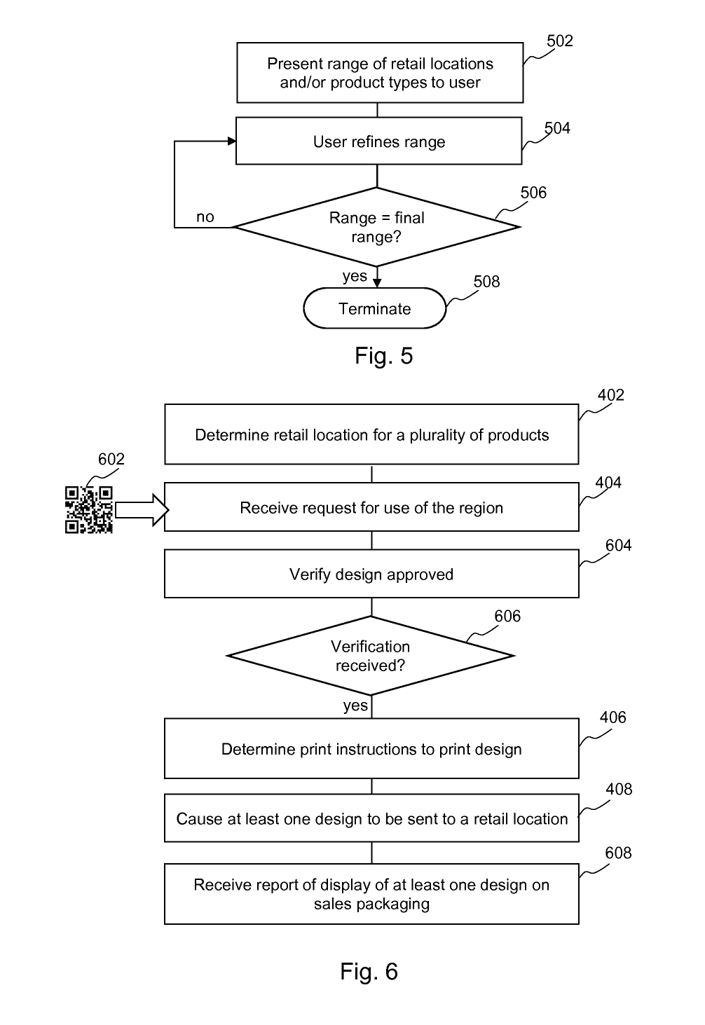

FIG. 5 is an example of a method of carrying out block 404 of with FIG. 4. In this example, the request may be iteratively defined. In block 502, an initial range of retail locations and/or product types is presented to a user and refined in block 504 until it is determined, in block 506, that the range of retail locations and/or product types is a final range of retail locations and/or product types. Once the range is the final range, the method terminates in block 508.

FIG. 6 is further example of a method for associating a design with a product. The blocks in common with FIG. 4 are provided with like numbers. In this example, the request comprises a code, which is an indication that a machine readable tag 602 has been read, the tag 602 being associated (for example via a look up table or database) with a product type bearing the tag 602 and/or retail location at which the tag 602 was applied. This provides an initial retail location and/or the product type of a request to use a display region of sales packaging. In some examples, the initial indication may be modified or refined before the request is submitted. In some examples, a design is requested before the request is submitted. In this example, the tag 602 is a Quick Response (QR) code, but other codes, such as alphanumeric codes or other forms of machine readable tags, such as bar codes, or Radio Frequency Identity tags, may be used.

In this example, prior to determining print instructions in block 406, the method comprises verifying that the design has an acceptable design content. This could comprise verifying that the design content is compatible with the brand holder's brand, the retail location and/or product type indicated in the request (block 604). The method proceeds if, in block 606, it is determined that approval is received. Otherwise the method may terminate. In other examples, a user may be prompted to specify new products and/or locations in such cases.

Following distribution of the designs (as printed designs or as print instructions), the method in this example further comprises, in block 608, receiving reports of the display of the design, for example of application of at least one label to sales packaging, or the display or sale of a product with packaging bearing the design. Such reports may for example be used to formulate fee payment, or to formulate new print instructions to print further designs. In some examples, the designs may be distributed with machine readable codes (which themselves may be in the form of labels in some examples and/or instruction for print a code may be included as part of the print instructions) to facilitate such reporting. In such example, receiving a report may comprise receiving a report that a machine readable tag has been read. Such reports may indicate handling of a design (as a label or as printed on sales packaging), for example printing of at least one design, transmission of at least one printed design or print instructions for example to a retail location, receipt of at least one printed design or print instructions, application of at least one printed design to a product sales packaging, display of product having sales packaging bearing a printed design and the like. Such reports may allow a status indication to be updated. In one example a recipient of labels bearing the design at a retail location may scan a tag to indicate the designs have been received, and another to provide an indication that at least one label has been applied to a product package. For example, this may be used to indicate when all the labels bearing the design received in a particular transmission have been applied to packages, which may prompt another action, such as the transmission of more designs, or the payment of fees, or the like. In some examples, a tag may be scanned or a code entered to provide access to an interface to report approval of the design, for example either indicating automatic approval or inviting feedback.

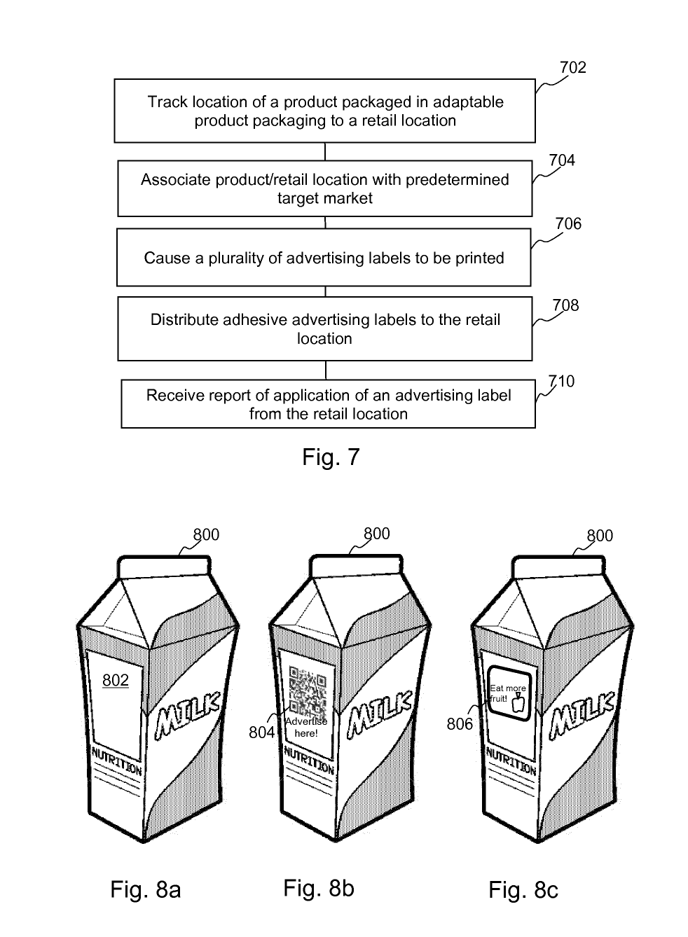

FIG. 7 is an example of a method comprising, in block 702, tracking the location of a product packaged in adaptable sales packaging to a retail location. In this example, the adaptable sales packaging comprising an advertising region thereof for receiving point of sales marketing material. In block 704, at least one of the product and the retail location is associated with a predetermined target market for an advertisement. Block 706 comprises causing a plurality of advertising labels bearing the advertisement to be printed. Block 708 comprises distributing, to the retail location, a plurality of adhesive advertising labels which are to be received by the advertising region of the adaptable sales packaging. Distributing may comprise causing the labels to be sent to the retail location. In block 710, at least one report of application of an advertising label is received from the retail location.

FIGS. 8a to 8c show a product packaged in adaptable product packaging 800, in this example milk packaging. As best seen in FIG. 8a, the packaging comprises a display region 802 to receive a label or be printed with a design. In FIG. 8b, a printed design 804 comprising a machine readable tag has been applied to the region 802. This printed design 804 may be a label or may be printed directly on the packaging. In this example, the tag is intended to provide a code, which is to provide an indication that a user would like to advertise on that product and/or on products bought from the retail location from which the product was purchased. This tag may for example be scanned as part of a request to for use of the display region 802. In this example, the tag comprises a QR code, although other machine readable codes such as bar codes or RFID tags could be used. In other examples, a code such as an alphanumeric code, could be provided and for example input manually by a promoter to an interface such as a web portal, or over the telephone or the like.

In FIG. 8c, a printed design 806, in this example comprising an advertising design or promotion has been applied to the display region 802. This printed design 806 may be a label or may be printed directly on the packaging. This printed design 806 may for example be a design printed according to the print instructions of block 406 or caused to be printed in block 706, or may be a design printed according to the output of a print instruction module 110.

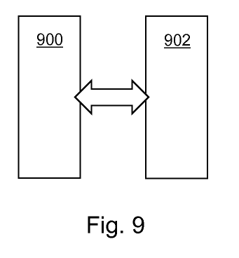

FIG. 9 is an example of a processor 900 in communication with a computer readable medium, in this example a memory 902. In some examples, the memory may comprise machine readable instructions which, when executed by the processor 900, cause the processor 900 to carry out any, or any portion of, the methods set out herein. In some examples, the processor 900 may comprise processing apparatus as described in relation to FIG. 4. The memory 902 may store data such as product data, location data, distribution data, addressing data, design data, machine readable tags data, reporting code data or the like. The memory 902 may store an association between any combination of products, locations, brand owners, promotors, reporting codes, addressing data, reporting data and design data, for example in a look up table, database or the like. In some examples, the memory 902 may comprise instructions which, when executed by the processor 900, generate machine readable tags.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A processing apparatus comprising:
a product module to identify products of a plurality of product types, each of the products having sales packaging, wherein the sales packaging of each of the products comprises a display region thereof which is to receive a design;
a location module to identify at least one retail location for a plurality of products identified in the product module;
a design module to receive a design to be displayed on at least one display region of the sales packaging of at least one product;
an allocation module to determine, for at least one design, a retail location at which the design is to be displayed and a product type on which the design is to be displayed;
a print instruction module to determine print instructions to print the design for display in a display region of the sales packaging of the product type determined by the allocation module; and
a distribution instruction module to determine a distribution instruction for sending at least one of a printed design and the print instructions to at least one retail location determined by the allocation module.

2. The processing apparatus according to claim 1 wherein the allocation module is to provide an interactive user interface, the interactive user interface being to receive user input of at least one of: an indication of a geographical zone for a retail location, an indication of the characteristics of a retail location, and an indication of at least one characteristic of a product type.

3. The processing apparatus according to claim 1 wherein the allocation module is to receive at least one indication of a retail location and/or product type as a code indicative that a machine readable tag applied to a product has been read.

4. The processing apparatus according to claim 1 further comprising a tracking module to track at least one handling of a design at the retail location.

5. The processing apparatus according to claim 1 further comprising an approval module to receive at least one approval of a design.

6. A method comprising
determining a retail location for a products of a plurality of product types, each of the products having sales packaging, wherein the sales packaging of each of the products comprises a display region thereof which is to display a design;
receiving a request for use of a display region, the request indicating a design, a retail location and product type;
determining print instructions to print the design for display in a display region of the sales packaging of a product of the product type indicated in the request; and
causing at least one of a printed design and the print instructions for the design to be sent to a retail location indicated in the request, wherein the design is for display at the retail location in a display region of the sales packaging of at least one product of the product type indicated in the request.

7. The method according to claim 6 wherein the indication of a retail location is an indication of a geographical zone, and causing at least one of a printed design and the print instructions for the design to be sent to a retail location comprises causing at least one of a printed design and the print instructions for the design to be sent to at least one location within the zone.

8. The method according to claim 6 wherein the indication of retail location is an indication of the characteristics of a retail location, and causing at least one of a printed design and the print instructions for the design to be sent to a retail location comprises causing at least one of a printed design and the print instructions for the design for the design to be sent to at least one retail location having the characteristics.

9. The method according to claim 6 wherein receiving the request comprises an iterative process in which an initial range of retail locations and/or product types is iteratively reduced to a final range of retail locations and/or product types.

10. The method according to claim 6, wherein receiving the request comprises receiving a code indicating that a machine readable tag has been read, the tag being associated with a product type bearing the tag and/or retail location at which the tag was applied.

11. The method according to claim 6 further comprising printing labels according to the print instructions, wherein the labels are self-adhesive labels.

12. The method according to claim 6 further comprising receiving reports of the application of at least one design to sales packaging.

13. The method according to claim 6 further comprising, prior to determining print instructions, verifying that the design has a design content which is compatible with the retail location and/or product type indicated in the request.

14. A method comprising:
tracking a location of a product packaged in adaptable sales packaging to a retail location, the adaptable sales packaging comprising an advertising region thereof;
associating at least one of the product and the retail location with a predetermined target market for an advertisement;
distributing, to the retail location, a plurality of advertising labels bearing the advertisement which are to be received by the advertising region of the packaging;
receiving, from the retail location, at least one report of application of an advertising label to an advertising region.

15. The method according to claim 14 further comprising, after associating at least one of the product and the retail location with a predetermined target market, causing the advertising labels to be printed.
